(19) United States
(12) Patent Application Publication
(10) Pub. No.: US 2010/0059010 A1
(43) Pub. Date: Mar. 11, 2010

(54) Heat Insulator For An Intake Manifold Of An Air-Cooled Charge Air Cooler

(76) Inventor: David F. Fijas, Depew, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/911,247

(22) PCT Filed: Mar. 13, 2006
(86) PCT No.: PCT/US06/08842

§ 371 Date: Oct. 27, 2009

Related U.S. Application Data
(60) Provisional application No. 60/661,641, filed on Mar. 14, 2005.

(51) Int. Cl. F02M 35/10

(52) U.S. Cl. 123/184.61

(57) ABSTRACT

A heat insulator for an intake manifold of an air-cooled charge air cooler is a rectangular box placed inside the intake manifold housing. The charge air coming into the intake manifold is passed to the inside of the box by a liner in the housing tube. One side of the box has a plurality of openings with outwardly extending walls for abutting directly with the tubes or plates of the heat exchanger section of the cooler. The box has outwardly extending protrusions for positioning the box inside the intake manifold housing, the protrusions being such that direct heat transfer between the box and the housing is minimal and the heat conduction through the housing wall is sufficient to keep the housing temperature significantly lower than the charge air temperature. The box is not air tight to allow relatively thin material to be used since there is no pressure differential between the outside and the inside of the box.

### TECHNICAL HELD

The present invention relates to the art of heat transfer; more particularly, to air-cooled charge air coolers; and most particularly to air-cooled charge air coolers for cooling air from a turbocharger before it enters an engine.

### BACKGROUND OF THE INVENTION

In order to maximize performance, diesel engines use turbochargers to compress the combustion air, thus increasing its density, and increasing the amount of oxygen available for combustion in the engine. During the course of compression, the temperature of the charge air is increased. Charge air coolers cool the charge air to further increase its density before the charge air enters the engine.

As environmental concerns have emerged, governments have placed limits on emissions from diesel engines. These limits have become more and more restrictive. In order to meet these emissions regulations, diesel engine designers have increased charge air pressures and temperatures.

A common air-cooled charge air cooler is made from aluminum, either tube and header designs or bar and plate designs. These heat exchangers have maximum temperature and pressure limits resulting from design considerations including the maximum allowable stress of aluminum at operating temperatures. The tensile strength of aluminum begins to decrease considerably above about 300° F. This means that the product must use heavier parts in order to contain the charge air pressure without failure.

Bar and plate designs tend to be more robust than tube and header designs. Even so, the inlet manifold and the inlet ends of the charge air passages are subject to the maximum charge air temperature. Some engine designs result in specifications of charge air temperatures of 500° F. or higher with operating pressures of 50 psig or higher. However, it is true that the metal temperature will be somewhat lower than the charge air inlet temperature due to heat transfer between the manifold and the ambient surrounding the charge air cooler. This temperature, which may be 50 to 75° F. lower than the inlet temperature, is still high enough to require the use of low allowable stresses for design of the charge air cooler.

What is needed is a means of lowering the charge air cooler metal temperature significantly more than 50 to 75° F. so that much higher stresses can be used for design purposes.

It is a primary object of the invention to lower the charge air cooler metal temperature significantly more than 50 to 75° F. so that much higher stresses can be used for design purposes.

### SUMMARY OF THE INVENTION

Briefly described, a heat insulator for an intake manifold of an air-cooled charge air cooler has an enclosure of a material that is able to retain its essential mechanical characteristics in an elevated temperature equal to the temperature of input air to the air-cooled charge air cooler, the enclosure being contained within a housing and having a contact area with said housing that is small in relation to the outside area of the enclosure. The enclosure has an opening for admitting the input air and an interface plate of the same material positioned to pass air through the open end of the enclosure directly to a plurality of hollow air passages in a heat exchanger. The enclosure is not sealed such that there is essentially no pressure differential between the outside and inside of the enclosure.

### BRIEF DESCRIPTION OF THE DRAWINGS

The present invention will now be described, by way of example, with reference to the accompanying drawings, in which:

FIG. 1A is a plan view of an air cooled charge-air cooler according to the present invention;

FIG. 1B is a side view of the air cooled charge-air cooler of FIG. 1A;

FIG. 2 is a perspective view of the intake manifold of the air cooled charge-air cooler of FIG. 1A;

FIG. 3 is a top view of an insert enclosed in the intake manifold;

FIG. 4 is a top view of the intake manifold of FIG. 2;

FIG. 5 is a cross sectional view of the intake manifold shown in FIG. 4;

FIG. 6 is a side view of the intake manifold of FIG. 2;

FIG. 7 is a sectional view of a portion of the intake manifold shown in FIG. 6; and

FIG. 8 is a cross sectional view of the intake manifold shown in FIG. 4 of another embodiment of the invention.

### DESCRIPTION OF THE PREFERRED EMBODIMENTS

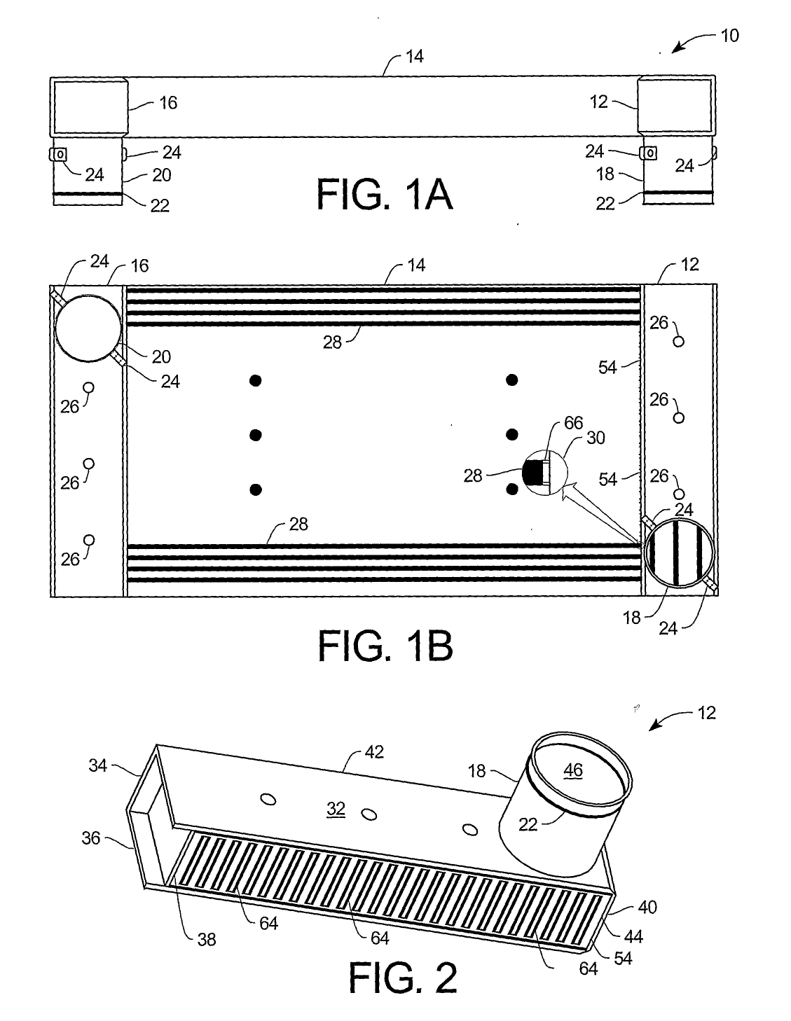

Referring to FIGS. 1A and 1B, an air cooled charge-air cooler 10 suitable for use with high temperature, high pressure outlet air from a turbocharger is shown. The air cooled charge-air cooler 10 has an intake manifold 12, a heat exchanger section 14, and an outlet manifold 16. The intake manifold 12 hose connector 18 and the outlet manifold hose connector 20 each have a raised ring 22 for retaining the hose onto the hose connectors 18 and 20, and may also have optional safety attachments 24 for the hose connections (not shown in the other figures). The intake manifold 12 and the outlet manifold 16 each have 3 holes 26 for reinforcing rods used to prevent the manifolds 12 and 16 from bulging outward. Shown in the heat exchanger section is a plurality of rectangular tubes 28 for passing the inlet air from the intake manifold 12 to the outlet manifold 16 and for cooling the air by transferring heat to coolant air flowing between the rectangular tubes 28. An enlargement of the interface between the intake manifold 12 and the rectangular tubes 28 is shown in circle 30.

In operation the high temperature, high pressure charge air enters the intake hose connector 18, distributed to the heat exchanger tubes 28 in the intake manifold 12, cooled in the heat exchanger 14, collected in the outlet manifold 16 and exits the air cooled charge-air cooler 10 through the hose connector 20.

FIG. 2 is a perspective view of the intake manifold 12. A top 32, right side 34, bottom 36 and two ends 38 and 40 form a five sided housing 42 that is made of aluminum of the type in which the tensile strength begins to decrease considerably above about 300° F. A housing insert 44 and a liner 46 for the hose connector 18 provide heat insulation in a novel form for the aluminum parts of the intake manifold 12. Advantageously, the required tension strength properties of the aluminum housing 42 and the hose connector 18 are not required of the housing insert 44 and the liner 46 as described below. In the preferred embodiment the housing insert 44 and the liner 46 are also made of aluminum. In an alternative embodiment the housing insert 44 and the liner 36 stainless steel.

With the present invention the hose connector 18, and the housing 42 are kept at least 250 to 350° F. below the approximately 500° F. inlet charge air, well within the normal design range for aluminum bar and plate heat exchangers.

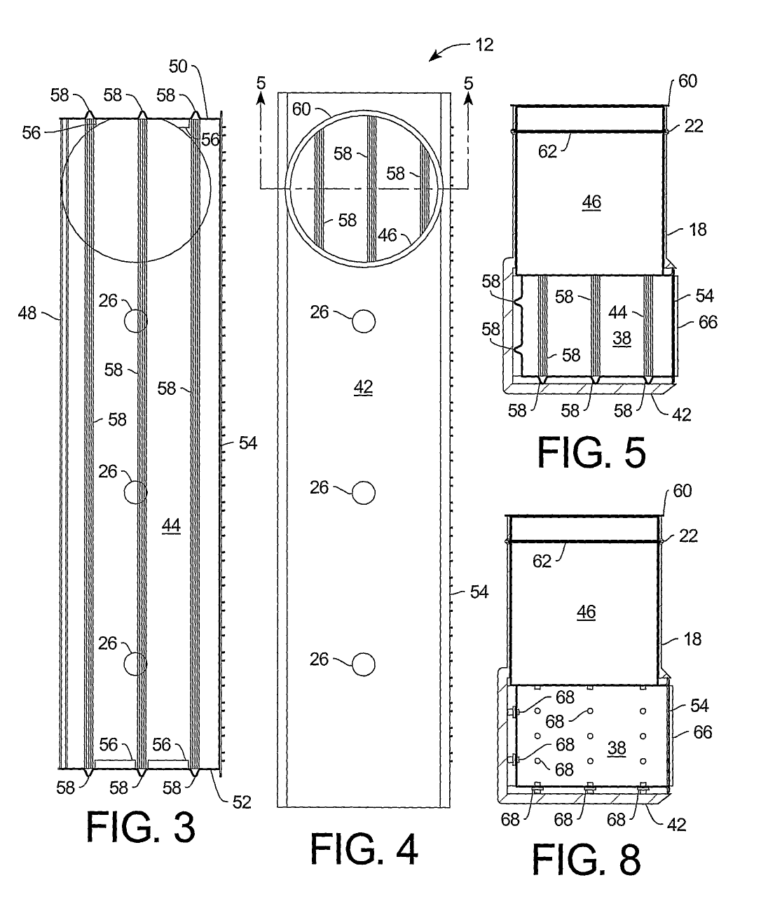

FIG. 3 is a top view of the housing insert 44. The housing insert 44 is formed from 4 parts, a generally U-shaped part 48, two end pieces 50 and 52, and an inlet sheet 54 so that a rectangular box is formed. The two end pieces 50 and 52 have clips 56 for holding the side pieces to the U-shaped part 48. The U-shaped part 48 and the two end pieces 50 and 52 have a plurality of protrusions 58 that form relatively small areas of contact between the aluminum housing of the intake manifold 12 and the housing insert 44.

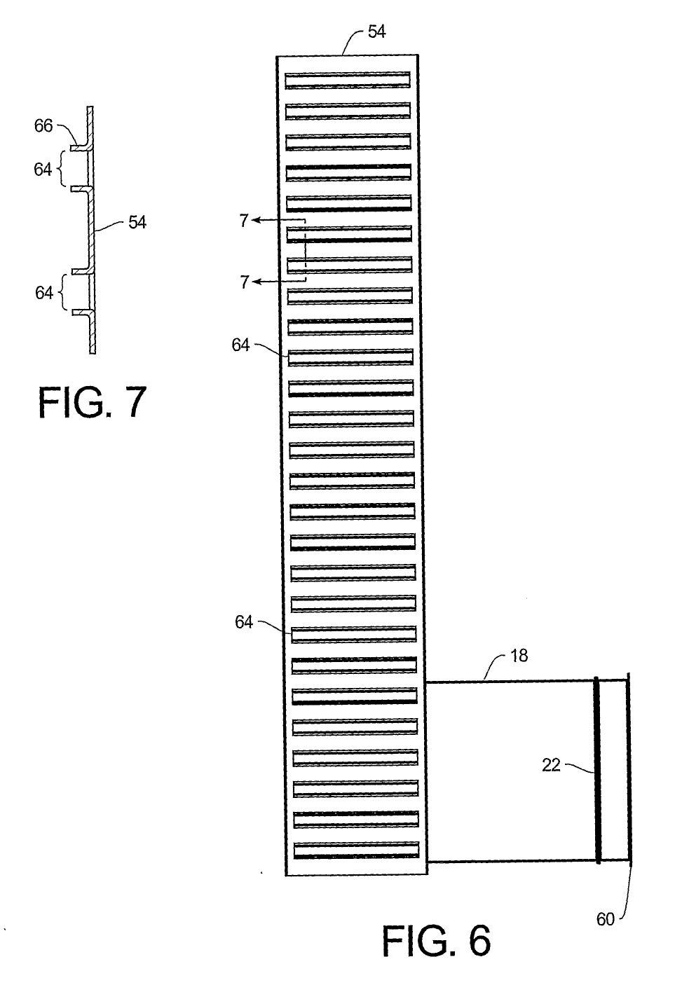

With reference now to FIGS. 4 and 5, the liner 46 located in the hose connector 18 has an upper lip 60 to shield the outer edge of the hose connector 18 from direct contact with the high temperature charge air, and extends from the top of the hose connector 18 to the top of the housing insert 44. The liner 46 has a raised outer ring 62 that fits inside the ring 22 of the hose connector 18 to help hold the liner 46 in place in the hose connector 18. The high temperature, high pressure charge air passing into the hose connector 18 is generally contained within the liner 46 and the housing insert 44 until it passes through a plurality of slots 64 in the inlet sheet 54 that have tabs 66 (best shown in FIGS. 6 and 7) extending away from the surface of the inlet sheet 54 and are aligned with, and make contact with, one end of the rectangular tubes 28 in the heat exchanger 14.

The housing insert 44 is not air tight, but inhibits the flow of air from inside the housing insert 44 to the cooler aluminum walls of the housing 42 on the intake manifold 12 so that heat from air touching the inside of the housing 42 is passed through the wall of the housing 42 to the outside ambient air. The hot air which transfers from the housing insert 44 to the aluminum housing 42 is cooled by the walls of the housing 42, and the volume of air passing across the inside walls of the aluminum housing 42 does not produce enough heat mass that can't be sufficiently cooled by the heat conduction through the walls of the housing 42, and thus the temperature of the housing 42 is kept significantly less than the charge air temperature entering the hose connector 18.

Also, the housing insert 44, though subject to direct contact with the incoming charge air, is submerged within the high-pressure charge air, so there is no pressure containment required of the housing insert 44 and consequently the tension characteristics that are required of the housing 42 and the hose connector 18 due to the high pressure inlet charge air are not required of the housing insert 44 and the liner 46. As a consequence, the housing insert 44 and liner 46 can be significantly thinner than the housing 42 and the hose connector 18.

Another concern obviated by the present invention is the joint between the internal passages of the intake manifold and the sheets between the header bars and face bars. First, the housing insert 44 shields the plane of the header bars from the incoming high temperature charge air. Second, the housing insert 44 uses the slots 64 to propel the charge air past this plane into the interior of the internal passages. This reduces the abrupt temperature change at this location due to the high temperature charge air in the internal passages of the intake manifold 12 and the relatively cold cooling air temperature on the outside of the charge air cooler 10.

FIG. 8 is a cross sectional view of the intake manifold shown in FIG. 4 of another embodiment of the invention. In this embodiment the protrusions 58 have been eliminated, and standoff pins 68 are used to space the housing insert 44 away from the walls of the housing 42.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A heat insulator for an intake manifold of an air-cooled charge air cooler comprising:
a) an enclosure contained within a housing of said intake manifold, said enclosure having an opening for receiving charge air and an interface region in a wall of said enclosure for passing charge air from said enclosure to a plurality of heat transfer passages in a heat exchanger; and
c) said enclosure being partially sealed such that most, but not all, of said charge air passes through said enclosure without making contact with said housing and there is essentially no pressure differential between the outside and inside of said enclosure.

2. The heat insulator of claim 1 wherein said enclosure is of a material that is able to retain a necessary mechanical characteristic at an elevated temperature equal to the temperature of said charge air.

3. The heat insulator of claim 2 wherein said necessary mechanical characteristic is having a tensile strength sufficient to remain solid without warping.

4. The heat insulator of claim 1 wherein said housing is of a material that is able to retain a necessary mechanical characteristic at the air pressure of said charge air.

5. The heat insulator of claim 4 wherein said necessary mechanical characteristics is having a tensile strength to retain substantially the same mechanical dimensions when receiving pressurized charge air as when receiving charge air at ambient pressure.

6. The heat insulator of claim 4 wherein said enclosure and said housing are made of the same material, wherein said same material would not provide said necessary mechanical characteristic of said housing if said housing was used without an inside heat insulator or heat sinks other than air at ambient temperature.

7. The heat insulator of claim 1 wherein said interface region has a plurality of openings for passing said charge air to said plurality of hollow air passages in said heat exchanger.

8. The heat insulator of claim 7 wherein said openings are rectangular.

9. The heat insulator of claim 7 wherein said openings have projections that project outside of said enclosure.

10. The heat insulator of claim 9 wherein said projections make contact with said hollow air passages in said heat exchanger when said enclosure is inside said housing and connected to said heat exchanger.

11. The heat insulator of claim 9 wherein each of said openings have only two projections.

12. The heat insulator of claim 1 wherein said enclosure has a contact area with said housing that is small in relation to the outside area of said enclosure.

13. The heat insulator of claim 12 wherein said contact area is comprised of the area of contact of a plurality of protrusions from said enclosure and said housing.

14. The heat insulator of claim 1 further comprising a hose connector attached to said housing for receiving said charge air and a liner inside said hose connection which extends to said enclosure such the said charge air flows into said enclosure substantially without contacting said hose connection.

15. The heat insulator of claim 14 wherein said liner has a lip which keeps said charge air from direct contact with an edge of said hose connection.

16. The heat insulator of claim 1 wherein said enclosure is spaced apart from said housing by a plurality of protrusions from said enclosure, whereby said enclosure has a contact area with said housing that is small in relation to the outside area of said enclosure.

17. The heat insulator of claim 1 wherein said enclosure is spaced apart from said housing by a plurality of pins, whereby said enclosure has a contact area with said housing that is small in relation to the outside area of said enclosure.
